(19) United States
(12) Patent Application Publication
(10) Pub. No.: US 2007/0216719 A1
(43) Pub. Date: Sep. 20, 2007

(54) Recording Apparatus

(75) Inventor: Koji Ito, Gifu-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/675,501

(22) Filed: Feb. 15, 2007

(30) Foreign Application Priority Data
Feb. 16, 2006 (JP) 2006-039269

(51) Int. Cl. B41J 29/38

(52) U.S. Cl. 347/17

(57) ABSTRACT

The apparatus includes a capacitor electrically connected to a driver IC and a temperature estimating unit that estimates the internal temperature of the capacitor. The unit estimates the internal temperature of the capacitor based on the operation temperature of the driver IC detected by a driver temperature detector.

### BACKGROUND OF THE INVENTION

1. Field of the Invention

The present invention relates to a recording apparatus that records characters, an image, or the like, on a recording medium.

2. Description of Related Art

In many recording apparatuses for recording desired characters, a desired image, or the like, on a recording medium, a driver for driving a recording element includes therein a capacitor, such as an electrolytic capacitor, in order to, for example, stabilize driving characteristics of the driver. For example, if the inductance of the line connecting the driver to a number of recording elements is high when each recording element must be driven at a high frequency in order to increase its recording rate, the driving current is not quickly supplied to each recording element and as a result, desired driving characteristics can not be obtained. In this case, therefore, a capacitor is provided between the driver and each driving element to reduce the impedance measured from the recording element side. This makes it possible to quickly supply the driving current to the recording element, and therefore the driving characteristic can be more stabilized.

On the other hand, in driving a recording element, a large current flows instantaneously, and the internal temperature of the capacitor increases due to loss generated at that time, in particular, heat generation caused by a ripple current as an AC component. If the internal temperature of the capacitor increases too high, the electrolyte in the capacitor gasifies and escapes. This shortens the life of the capacitor. An increase in the temperature of the capacitor due to heat generation by the ripple current is proportional to the equivalent series resistance (ESR) in the capacitor. In general, the higher the capacitance of the capacitor is, the lower the equivalent series resistance is. Therefore, an increase in the temperature due to the ripple current can be suppressed by adopting a capacitor of a high capacitance. In general, however, such a capacitor of a high capacitance is large in size and expensive. Thus, adopting a capacitor of a capacitance more than necessity for the above-described stabilization of the driving characteristic brings about an increase in size and cost of the system. For this reason, it is preferable that an inexpensive capacitor of a low capacitance is adopted and a recording apparatus has a feature for preventing an excessive increase in the temperature of the capacitor.

A technique relating to the above problem is known as follows. For example, a fixing system of a thermal printer is known that includes therein a Xe lamp to irradiate a thermosensitive recording paper with fixing lights, an electrolytic capacitor to be charged with a voltage to be supplied to the Xe lamp, and a temperature sensor to measure the surface temperature of the electrolytic capacitor. The fixing system is constructed so as to stop the light emission of the Xe lamp when the surface temperature of the electrolytic capacitor measured by the temperature sensor is not less than a set temperature set in advance. Thereby, the electrolytic capacitor is prevented from excessively increasing in temperature.

By using the above technique, even when an inexpensive capacitor of a low capacitance is adopted, the capacitor can be prevented from excessively increasing in temperature. On the other hand, however, because the system has need of provision of the temperature sensor only for measuring the surface temperature of the electrolytic capacitor, this increases the cost of the system accordingly.

### SUMMARY OF THE INVENTION

An object of the present invention is to provide a recording apparatus wherein an inexpensive capacitor of a low capacitance can be adopted and the capacitor can be prevented from excessively increasing in temperature with using no purpose-built temperature sensor.

According to the present invention, a recording apparatus comprises an element driver that drives a recording element; a driver controller that controls the element driver; a capacitor electrically connected to the element driver; a first temperature detector that detects an operation temperature of the element driver; and a temperature estimating unit that estimates an internal temperature of the capacitor on the basis of the operation temperature of the element driver detected by the first temperature detector.

According to the invention, because the temperature estimating unit estimates the internal temperature of the capacitor on the basis of the operation temperature of the element driver detected by the first temperature detector, the internal temperature of the capacitor can be monitored. Therefore, even when an inexpensive capacitor having a low capacitance is adopted in order to realize reductions in cost and size of the recording apparatus, the driving state of the element driver can be changed on the basis of the estimated internal temperature so as to prevent the capacitor from excessively increasing in temperature, or a user can be warned that the internal temperature of the capacitor has increased. In addition, because there is no need of provision of a purpose-built temperature sensor or the like only for monitoring the internal temperature of the capacitor, this suppresses the cost of the recording apparatus.

### BRIEF DESCRIPTION OF THE DRAWINGS

Other and further objects, features and advantages of the invention will appear more fully from the following description taken in connection with the accompanying drawings in which:

FIG. 1 shows a general construction of an inkjet printer according to an embodiment of the present invention;

FIG. 2 is a vertically sectional view of an inkjet head shown in FIG. 1;

FIG. 3 is a plan view of a head main body shown in FIG. 2;

FIG. 4 is an enlarged view of a region B shown by an alternate long and short dash line in FIG. 3;

FIG. 5 is a sectional view of the head main body;

FIG. 6A is a sectional view of an actuator;

FIG. 6B is a plan view of an individual electrode;

FIG. 7 is a block diagram showing an electrical construction of the printer;

FIG. 8 is a graph showing a relation between the temperature increase quantity delta Td of a driver IC and the internal temperature Tc of a capacitor;

FIG. 9 is a flowchart showing a series of controls including estimation of the internal temperature of a capacitor and stopping of a recording operation based on the estimation, in the printer according to the embodiment of the present invention; and

FIG. 10 is a flowchart showing a series of controls including estimation of the internal temperature of a capacitor and inhibition of a recording operation based on the estimation, in the printer according to a modification of the embodiment.

### DESCRIPTION OF THE PREFERRED EMBODIMENTS

Hereinafter, a preferred embodiment of the present invention will be described. The embodiment is an example in which the present invention is applied to an inkjet printer that ejects ink onto a recording paper to record characters, an image, or the like.

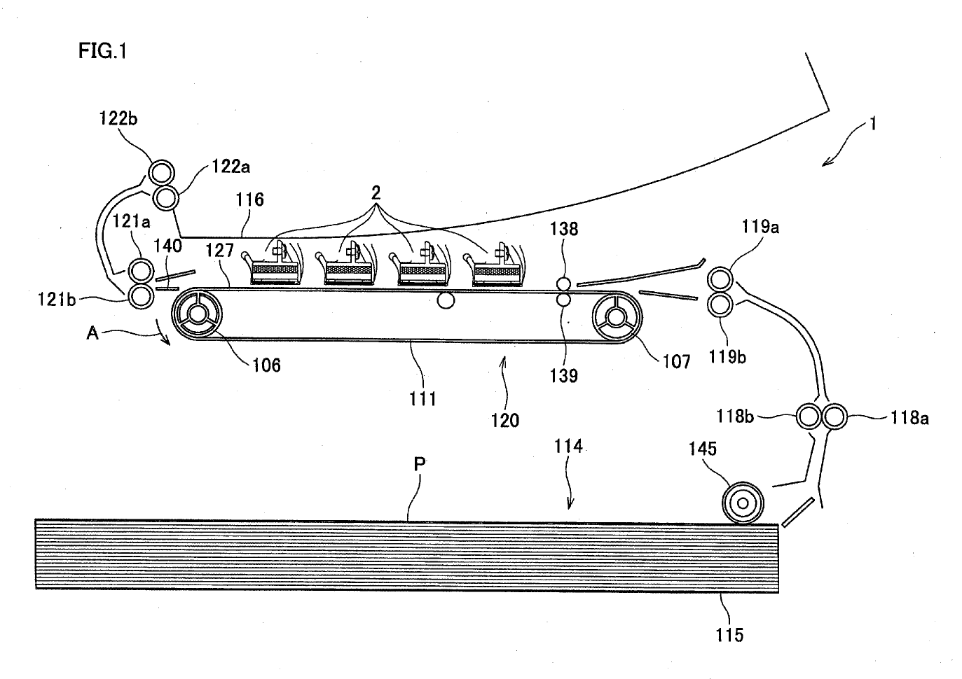

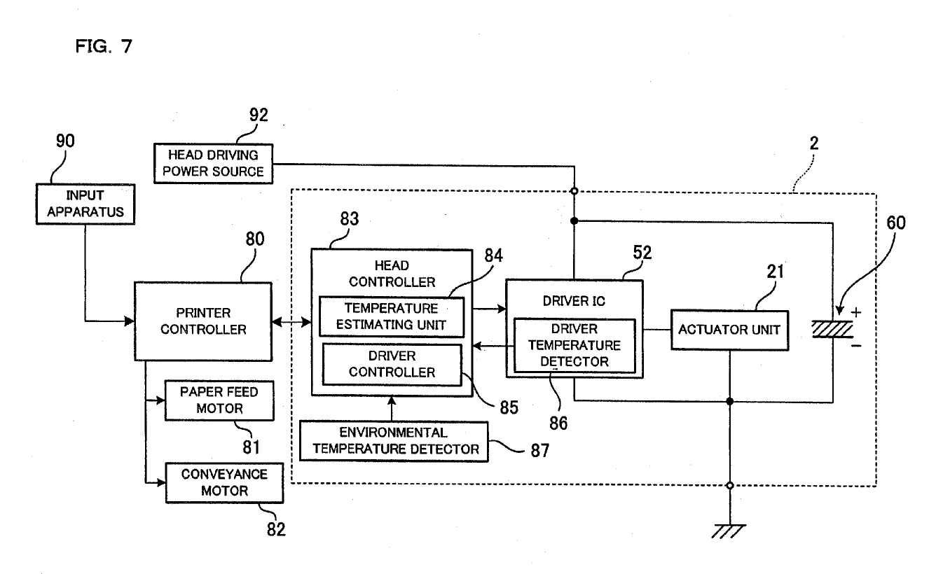

First, a construction of the printer 1, as a recording apparatus, according to the embodiment, will be briefly described. As shown in FIG. 1, the printer 1 is a color inkjet printer that has four line type inkjet heads 2 each extending perpendicularly to FIG. 1. Four kinds of inks, that is, cyan, magenta, yellow, and black, are ejected from the respective inkjet heads 2 onto a recording paper P, and thereby a color image can be recorded. The printer 1 further includes therein a paper feeder 114, a paper receiver 116, and a conveyance unit 120. Operations of the inkjet heads 2, the paper feeder 114, the conveyance unit 120, and so on, are controlled by a printer controller 80 as shown in FIG. 7.

The paper feeder 114 includes a paper container 115 that can contain therein a number of rectangular recording papers P stacked; and a paper feed roller 145 that send out the upper most recording paper P in the paper container 115 one by one toward the conveyance unit 120. Each recording paper P is contained in the paper container 115 so that the paper P is sent out along its long side. Between the paper container 115 and the conveyance unit 120, two pairs of feed rollers 118a and 118b; and 119a and 119b are disposed along the conveyance path. The paper feed roller 145 is driven to rotate, by a paper feed motor 81 as shown in FIG. 7. Each recording paper P taken out of the paper feeder 114 by the paper feed roller 145 is moved upward in FIG. 1 by the feed rollers 118a and 118b, and then leftward by the feed rollers 119a and 119b toward the conveyance unit 120.

The conveyance unit 120 includes an endless conveyor belt 111, a drive roller 106, and a slave roller 107. The conveyor belt 111 is wrapped on the drive roller 106 and the slave roller 107. A nip roller 138 and a nip receiving roller 139 are disposed near the slave roller 107 to nip the conveyor belt 111. The recording paper P is nipped by the rollers 138 and 139 to be pressed onto the conveyance surface, that is, the upper surface, of the conveyor belt 111.

The drive roller 106 is driven to rotate in the direction of an arrow A in FIG. 1, by a conveyance motor 82 as shown in FIG. 7. The recording paper P sent from the paper feeder 114 to the conveyance unit 120 is conveyed leftward by the conveyor belt 111, and in this state, desired characters, a desired image, or the like, is recorded on the upper surface of the paper P by four inkjet heads 2. On the left side of the conveyance unit 120, a peeling plate 140 is provided for peeling off the recording paper P conveyed, from the conveyance surface of the conveyor belt 111. Each recording paper P on which an image or the like has been recorded is sent to the paper receiver 116 by two pairs of feed rollers 121a and 121b; and 122a and 122b. A number of recording papers P are stacked on the paper receiver 116.

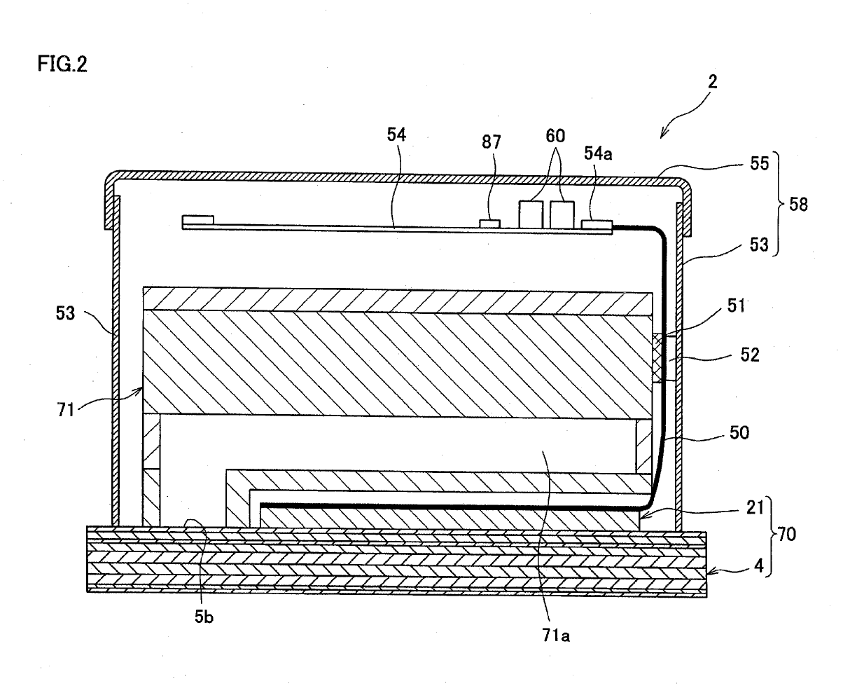

Next, the inkjet heads 2 will be described. FIG. 2 is a vertically sectional view of an inkjet head 2 taken along a vertical plane perpendicular to a longitudinal axis of the head 2. As shown in FIG. 2, the inkjet head 2 includes a head main body 70, a reservoir unit 71 disposed on the upper face of the head main body 70 to supply ink into the head main body 70, and a head substrate 54 on which a head controller 83 as shown in FIG. 7 is provided for controlling the operation of the inkjet head 2. The head main body 70 includes a passage unit 4 and an actuator unit 21.

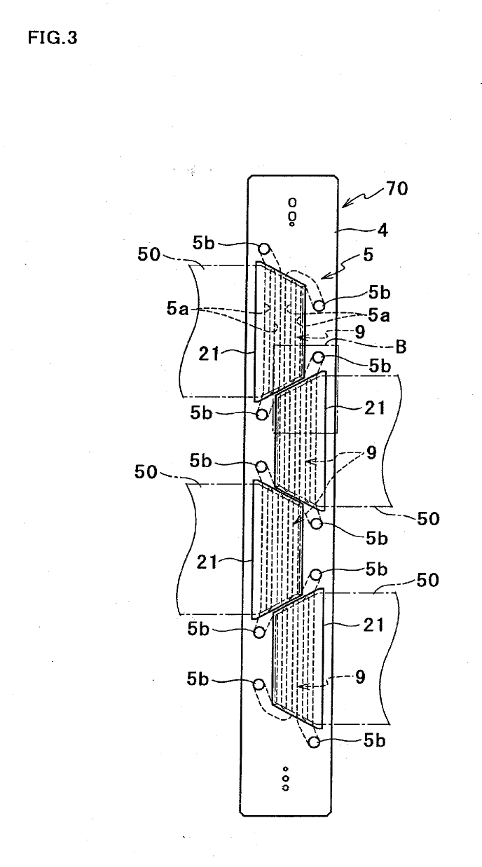

In the head main body 70, the actuator unit 21 is disposed on the upper face of the passage unit 4 in which ink passages each including a nozzle for ejecting ink are formed. As shown in FIGS. 2 and 3, ten ink supply openings 5b connected with the internal ink passages are formed on the upper face of the passage unit 4. A flexible printed circuit (FPC) 50 on which a driver IC 52 is mounted is connected to the upper face of the actuator unit 21. The FPC 50 is connected, through a connector 54a, also to the head substrate 54 disposed horizontally over the reservoir unit 71. On the basis of an instruction from a head controller 83 as shown in FIG. 7 provided on the head substrate 54, the driver IC 52 supplies a driving signal to the actuator unit 21 through wiring provided on the FPC 50. Capacitors 60, in this embodiment, electrolytic capacitors, are provided on the head substrate 54 in parallel with the driver IC 52 in order to stabilize characteristics of the driver IC 52 driving the actuator unit 21. Constructions of the passage unit 4 and the actuator unit 21 will be described later in more detail.

The reservoir unit 71 is disposed above the head main body 70. The reservoir unit 71 has therein an ink reservoir 71a for storing ink. The ink reservoir 71a is connected with each ink supply opening 5b of the passage unit 4. Thus, ink in the ink reservoir 71a is supplied to each ink passage in the passage unit 4 through the ink supply opening 5b.

The above-described actuator unit 21, reservoir unit 71, head substrate 54, and FPC 50 are covered with a cover unit 58 constituted by a side cover 53 and a head cover 55. This prevents intrusion of ink having externally flown and ink mist. The cover unit 58 is made of a metallic material. An elastic sponge 51 is interposed between a side face of the reservoir unit 71 and the FPC 50 at the opposite position of the FPC 50 to the driver IC 52. The sponge 51 presses the driver IC 52 onto the inner surface of the side cover 53. Thus, heats generated in the driver IC quickly diffuse to the external through the metallic cover unit 58. That is, the cover unit 58 serves also as a radiator.

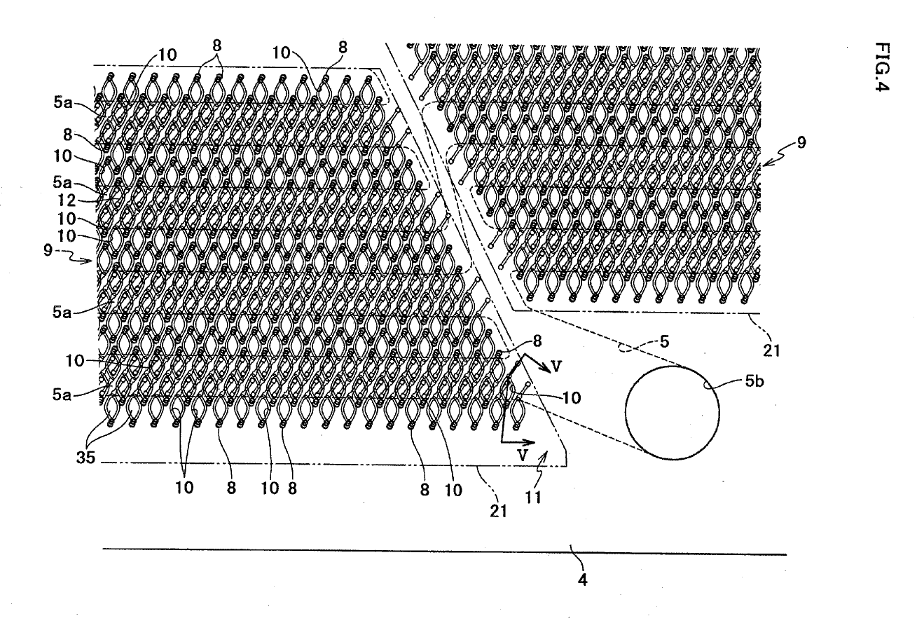

Next, the head main body 13 will be described in detail. FIG. 3 is a plan view of the head main body 13 shown in FIG. 2. FIG. 4 is an enlarged view of a region B enclosed with an alternate long and short dash line in FIG. 3. As shown in FIGS. 3 and 4, a large number of pressure chambers 10 that constitute four pressure chamber groups, and a large number of nozzles 8 connected with the respective pressure chambers 10 are formed in the passage unit 4 of the head main body 13. Four substantially trapezoidal actuator units 21 are bonded onto the upper face of the passage unit 4 in a zigzag arrangement in two rows.

Each region of the lower face of the passage unit 4, which is corresponding to the bonding region of each actuator unit 21, serves as an ink ejection region where a large number of ejection openings of the nozzles 8 are disposed. As shown in FIG. 4, the pressure chambers 10 each substantially rhombic in plan view are arranged in two directions in a matrix in the upper face of the passage unit 4. One pressure chamber group 9 is constituted by a number of pressure chambers 10 being within the region of the upper face of the passage unit 4 corresponding to the bonding region of one actuator unit 21.

In this embodiment, as shown in FIG. 3, the pressure chambers 10 arranged longitudinally of the passage unit 4 at regular intervals are arranged laterally of the passage unit 4 in sixteen rows parallel to each other. In accordance with the trapezoidal shape of each actuator unit 21, the number of pressure chambers 10 belonging to each pressure chamber row gradually decreases from the long side toward the short side of the trapezoidal shape of the actuator unit 21. The nozzles 8 are in the same arrangement as the pressure chambers 10. Thereby, as a whole, image formation is possible at a resolution of 600 dpi.

As shown in FIGS. 3 and 4, manifold channels 5 connected with ink inlet openings 5b, and sub manifold channels 5a branching off from the manifold channels 5 are formed in the passage unit 4. Each manifold channel 5 extends along an oblique side of the corresponding actuator unit 21 to cross a longitudinal axis of the passage unit 4. In a region between two actuator units 21, one manifold channel 5 is shared by the neighboring actuator units 21. Sub manifold channels 5a branch off from both sides of the manifold channel 5. Each sub manifold channel 5a extends longitudinally of the passage unit 4 in a region opposite to the corresponding trapezoidal ink ejection region.

As shown in FIG. 4, a large number of nozzles 8 are arranged longitudinally of the passage unit 4. Each nozzle 8 is connected with a sub manifold channel 5a through a pressure chamber 10 and an aperture 12 that serves as a restricted passage. In FIG. 4, for the purpose of easy understanding, each actuator unit 21 is shown by an alternate long and two short dashes line. Further, each pressure chamber 10 and each aperture 12 are shown by solid lines though they should be shown by broken lines because they are under the corresponding actuator unit 21.

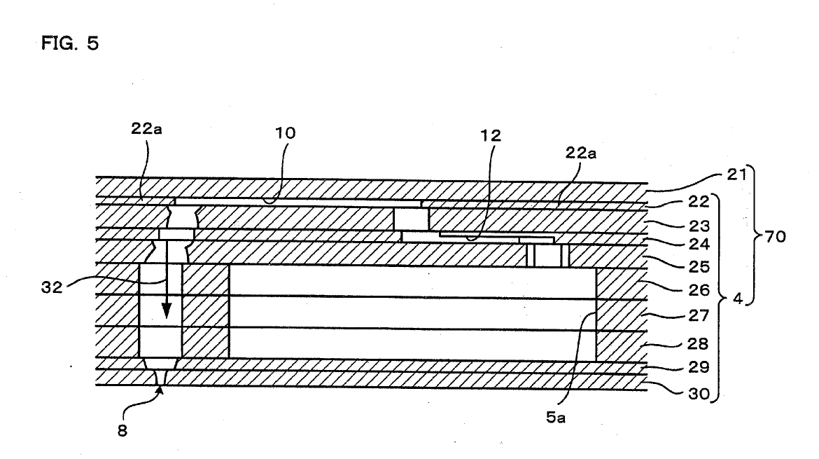

Next, a sectional construction of the head main body 13 will be described. As described above, the head main body 13 is formed by bonding the actuator units 21 onto the passage unit 4. As shown in FIG. 5, the passage unit 4 has a layered structure in which nine metallic plates are put in layers, that is, from the upper side, a cavity plate 22, a base plate 23, an aperture plate 24, a supply plate 25, manifold plates 26, 27, and 28, a cover plate 29, and a nozzle plate 30. Holes formed in the respective metallic plates 22 to 30 constitute an individual ink passage 32 leading from the outlet of a sub manifold channel 5a via an aperture 12 and a pressure chamber 10 to a nozzle 8.

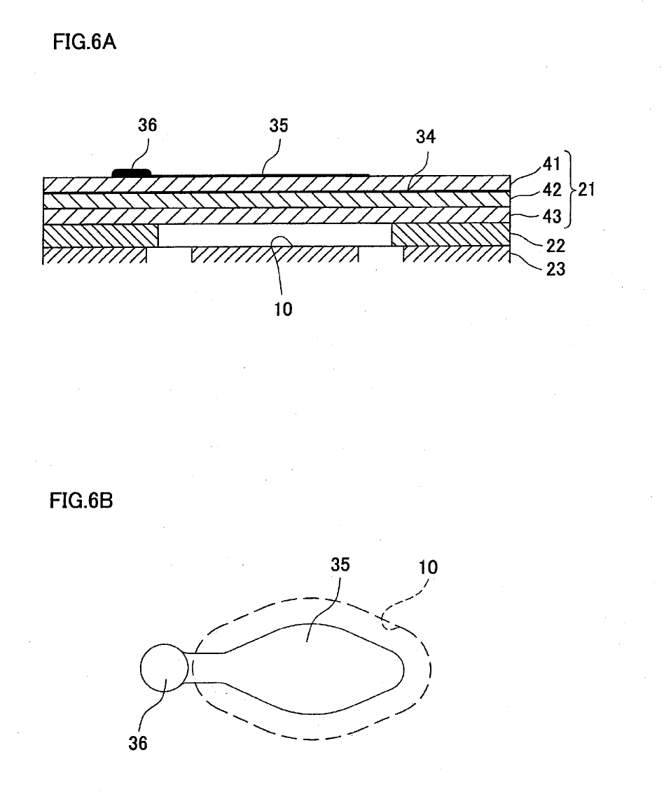

Next, the actuator units 21 will be described. As shown in FIG. 6A, each actuator unit 21 includes four piezoelectric sheets 41, 42, 43, and 44 put in layers. The actuator unit 21 further includes a large number of individual electrodes 35 formed on the upper surface of the uppermost piezoelectric sheet 41, and a common electrode 34 interposed between two piezoelectric sheets 41 and 42.

Each of the piezoelectric sheets 41 to 44 is made of a lead zirconate titanate (PZT)-base ceramic material having ferroelectricity. The piezoelectric sheets 41 to 44 are disposed over all pressure chambers 10 belonging to one pressure chamber group 9, as shown in FIGS. 3 and 4, formed in one ink ejection region of the head main body 13.

Each of the individual electrodes 35 and common electrode 34 is made of a metallic material, for example, an Ag—Pd-base metallic material. As shown in FIG. 6B, each individual electrode 35 has a substantially rhombic shape in plan view, slightly smaller than the corresponding pressure chamber 10. One acute end of the substantially rhombic individual electrode 35 is extended to a portion where no pressure chamber 10 is formed in the cavity plate 22, that is, a column portion. A protruding land 36 is formed at the front end of the extension of the individual electrode 35. The land 36 is made of, for example, gold containing glass frits. Wiring provided on the FPC 50 is connected to the land 36. That is, any individual electrode 35 is connected to the driver IC 52 through the corresponding land 36 and the FPC 50 so that the driver IC 52 can selectively apply a predetermined driving voltage between the individual electrode 35 and the common electrode 34.

The common electrode 34 is interposed between the uppermost piezoelectric sheet 41 and the second uppermost piezoelectric sheet 42 over the whole sheet area. Thus, a portion of the uppermost piezoelectric sheet 41 corresponding to each pressure chamber 10 is sandwiched by an individual electrode 35 and the common electrode 34. The portion of the uppermost piezoelectric sheet 41 serves as an active portion that constricts perpendicularly to polarization when a difference in potential is generated between the individual electrode 35 and the common electrode 34. That is, a unit actuator structure as shown in FIG. 6A is formed in the layered body constituted by four piezoelectric sheets 41 to 44, so as to correspond to each pressure chamber 10. Each actuator unit 21 is thus constructed. Although not shown, a surface electrode is formed on the upper surface of the uppermost piezoelectric sheet 41 in addition to the individual electrodes 35. The surface electrode is electrically connected to the common electrode 34 via a through hole formed through the piezoelectric sheet 41. Like the individual electrodes 35, the surface electrode is connected to wiring provided on the FPC 50. That is, the common electrode 34 is connected to the driver IC 52 via the surface electrode and the FPC 50. The driver IC 52 keeps the common electrode 34 at a predetermined reference potential, for example, the ground potential.

Next, an operation of an actuator unit 21 at the time of ink ejection will be described. At the time of ink ejection, on the basis of an instruction of a head controller 83, as shown in FIG. 7, provided on the head substrate 54 as shown in FIG. 2, the driver IC 52 applies a driving voltage between an individual electrode 35 and the common electrode 34. In the actuator unit 21, polarization of the piezoelectric sheet 41 is generated along the thickness of the sheet 41. The actuator unit 21 has a so-called unimorph type structure in which the uppermost piezoelectric sheet 41 serves as an active layer having therein active portions, and the remaining three piezoelectric sheets 42 to 44 are inactive layers. Therefore, when the driver IC 52 applies a positive or negative potential to an individual electrode 35 and for example, the electric field induced thereby is parallel to the polarization of the piezoelectric sheet 41, a portion of the piezoelectric sheet 41 sandwiched by the individual electrode 34 and the common electrode 35, to which the electric field is applied, serves as an active portion and constricts by the transversal piezoelectric effect parallel to a plane perpendicular to the polarization. On the other hand, the remaining three piezoelectric sheets 42 to 44 do not constrict by themselves because they are not influenced by the electric field. Thus, a difference in planar distortion is generated between the uppermost piezoelectric sheet 41 and the remaining three piezoelectric sheets 42 to 44. As a result, the whole of the piezoelectric sheets 41 to 44 has tendency to be deformed convexly toward the pressure chamber 10, that is, the downside.

At this time, however, as shown in FIG. 6A, the lower face of the piezoelectric sheets 41 to 44 is fixed to the upper face of the cavity plate 22 at column portions of the cavity plate 22. As a result, four piezoelectric sheets 41 to 44 are deformed convexly toward the pressure chamber 10. Therefore, the volume of the pressure chamber 10 decreases and the pressure of ink increases. Ink is thereby ejected out through the corresponding nozzle 8. Afterward, when applying the driving voltage between the individual electrode 35 and the common electrode 34 is stopped and the individual electrode 35 restores to the same potential as the common electrode 34, the piezoelectric sheets 41 to 44 restore to their original shapes so that the pressure chamber 10 restores to its original volume. Thereby, ink is sucked from the corresponding manifold channel 5.

Another driving method may be employed in which each individual electrode 35 is set in advance to a different potential from that of the common electrode 34. When receiving each ejection request, the corresponding individual electrode 35 is once set to the same potential as the common electrode 34, and then the individual electrode 35 is set back to the different potential from that of the common electrode 34 at a predetermined timing. In this method, at a timing when the individual electrode 35 is set to the same potential as the common electrode 34, the piezoelectric sheets 41 to 44 restore to their original shapes. Thereby, the corresponding pressure chamber 10 increases in volume from its initial state, that is, the state when the individual electrode 35 differs in potential from the common electrode 34. As a result, ink is sucked into the pressure chamber 10 from the corresponding manifold channel 5. Afterward, at a timing when the individual electrode 35 is set back to the different potential from that of the common electrode 34, the piezoelectric sheets 41 to 44 are deformed convexly toward the pressure chamber 10 and the pressure of ink increases due to the decrease in the volume of the pressure chamber 10. Thereby, ink is ejected through the corresponding nozzle B.

In the above description, one nozzle 8, one pressure chamber 10 connected with the nozzle 8, and a portion of the actuator unit 21 corresponding to the pressure chamber 10 correspond to a recording element of the present invention that is driven by the driver IC 52 as an element driver to record one pixel on a recording paper P.

The head substrate 54 connected to an external head driving power source 92 as shown in FIG. 7 is connected to the individual electrodes 35 on each actuator unit 21 via the relatively long FPC 50 extending along a side face to the downside of the reservoir unit 71. The inductance of wiring provided on the FPC 50 is high to an extent. Therefore, when the driver IC 52 drives an actuator unit 21 at a high frequency in order to increase the recording rate, the impedance of the power supply system can not be ignored. As a result, a voltage drop arises and a desired driving current may not quickly be supplied to a target individual electrode 35 due to the voltage drop. In other words, each individual electrode 35 and the common electrode 34 of the actuator unit 21 and the piezoelectric sheet 41, as shown in FIG. 6A, as a dielectric body, made of PZT, sandwiched by the electrodes 34 and 35, are considered to constitute a kind of a capacitor, hereinafter referred to as PZT capacitor. In the above case, the PZT capacitor of the actuator unit 21 can not fully be charged in a predetermined driving cycle. As a result, a desired pressure can not be applied to ink in the corresponding pressure chamber 10 at a proper timing. This makes it hard to realize desired droplet ejection characteristics, such as the volume of each droplet and the speed of each droplet.

For the above reason, as shown in FIG. 7, a capacitor 60 is electrically connected to the driver IC 52 so as to stabilize driving characteristics of the driver IC 52. For the capacitor 60 usable is an electrolytic capacitor such as an aluminum electrolytic capacitor, a tantalum electrolytic capacitor, or a polymer solid electrolytic capacitor. The capacitor 60 is connected in parallel with the driver IC 52. The provision of the capacitor 60 reduces the impedance of the power supply system from the driver IC 52 to the actuator unit 21, and the driving characteristics are more stabilized.

The capacitor 60 is connected in series with the head driving power source 92, which charges the capacitor 60 while the driver IC 52 is driven. In accordance with the capability of the head driving power source 92, the power to be supplied may be deficient instantaneously when a number of PZT capacitors are charged. Even in this case, the capacitor 60 discharges and thereby serves to compensate the deficiency of the power to be supplied. The driving stability of the actuator unit 21 is thus kept.

The capacitance of the capacitor 60 is generally determined as follows. When C0 represents the capacitance of the capacitor 60; C1 represents the total of the capacitances of PZT capacitors of an actuator unit 21 to be driven, that is, charged, at once; V1 represents the driving voltage of the driver IC 52; V2 represents the minimum voltage required to be applied between the individual electrodes 35 and the common electrode 34 in a predetermined cycle; and n represents the times of charging and discharging operations in a driving cycle, the following. Expression 1 is obtained.

$$\frac{V 2}{V 1} = \frac{1}{1 + \frac{n \cdot C 1}{C 0}} \qquad [ Expression 1 ]$$

That is, to ensure the driving voltage of V2 or more in high-frequency driving, it is only necessary to adopt a capacitor 60 having its capacitance not less than C0 determined by the Expression 1. In a modification, in order to further reduce the impedance in high-frequency driving, the capacitor 60 may be constituted by an electrolytic capacitor and a ceramic capacitor connected in parallel with the electrolytic capacitor.

Next, an electrical construction of the printer 1 will be described with reference to FIG. 7. The printer 1 includes a printer controller 80 and power sources. The printer controller 80 controls operations of various components of the printer 1, such as electric circuits, the paper feeder 114, the conveyance unit 120, and so on. The power sources supply powers necessary for operations of components of the printer 1, including the printer controller 80. For convenience of explanation, FIG. 7 shows only the above-described head driving power source 92 as a power source.

As shown in FIG. 7, the printer controller 80 of the printer 1 is for controlling various operations of the printer 1, such as the ink ejection operation of each inkjet head 2, the paper feed operation by the paper feed roller 145, and the conveyance operation for a recording paper P by the conveyance unit 120. The printer controller 80 is constituted by a central processing unit (CPU) as an arithmetic processing unit; a read only memory (ROM) storing therein computer programs to be executed by the CPU and data used in the programs; a random access memory (RAM) for temporarily storing therein data in execution of a program; an input/output interface; a bus; and so on. On the basis of data concerning an image or the like to be recorded, input from an external input apparatus 90 such as a personal computer (PC), the printer controller 80 controls various components of the printer 1, such as the driver IC 52 for each inkjet head 2, a paper feed motor 81 for driving the paper feed roller 145 as shown in FIG. 1, and a conveyance motor 82 for driving the driving roller as shown in FIG. 1.

A head controller 83 is provided on the head substrate 54, as shown in FIG. 2, of each inkjet head 2. The head controller 83 controls the ink ejection operation of the inkjet head 2. Like the printer controller 80, the head controller 83 is also constituted by a CPU, a ROM, a RAM, and so on. The head controller 83 is electrically connected to the driver IC 52 mounted on the FPC 50, as shown in FIG. 2, via wiring provided on the FPC 50. The head controller 83 includes therein a driver controller 85 that controls the driver IC 52 as an element driver. As described above, the driver IC 52 is electrically connected to the individual electrodes 35 and the common electrode 34 of each actuator 21 via wiring provided on the FPC 50. On the basis of a signal sent from the driver controller 85 of the head controller 83, the driver IC 52 selectively applies a predetermined driving voltage between a number of individual electrodes 35 and the common electrode 34. The power necessary at this time is supplied from the head driving power source 92, and deficiency of the power that may arise instantaneously is compensated by the capacitor 60. That is, the actuator unit 21 is electrically connected to the head driving power source 92 and the capacitor 60 via the driver IC 52.

The driver IC 52 has therein a driver temperature detector 86, as a first temperature detector, that detects the operation temperature of the driver IC 52 for the purpose of monitoring whether or not the operation temperature exceeds a predetermined operation upper limit temperature, for example, about 100 degrees C. when the rated temperature of the IC is 120 degrees C. For the driver temperature detector 86 usable is a semiconductor temperature sensor, that is, a PN-junction diode temperature sensor, or the like. An environmental temperature detector 87, as a second temperature detector, is provided on the head substrate 54 so as to detect the environmental temperature around the inkjet head 2. For the environmental temperature detector 87 usable is a semiconductor temperature sensor, a thermistor, or the like. The operation temperature of the driver IC 52 detected by the driver temperature detector 86 and the environmental temperature detected by the environmental temperature detector 87 are sent to the head controller 83.

Because a change in the environmental temperature causes a change in the viscosity of ink, the value of the driving voltage necessary for realizing a desired droplet ejection characteristic varies in accordance with the environmental temperature. Thus, the head controller 83 properly sets the value of the driving voltage to be applied by the driver IC 52 between individual electrodes 35 and the common electrode 34 of the actuator unit 21, to an appropriate value in accordance with the environmental temperature detected by the environmental temperature detector 87. In a modification, in place of changing the value of the driving voltage, the width of the voltage pulse to be applied may be changed. In the modification, the circuit construction of the power source can be simplified in comparison with the case of changing the value of the driving voltage.

As described above, the capacitor 60 is connected in parallel with the driver IC 52 in order to stabilize the driving characteristics of the actuator unit 21. From the viewpoint of stabilization of the driving characteristics, the capacitance of the capacitor 60 suffices if it satisfies the Expression 1 at the very least so that the voltage drop falls within a predetermined range. Thereby, the printing quality can be kept at a certain level. More ideally, the capacitance of the capacitor 60 may be determined such that at least the voltage to be applied between the electrodes of each PZT capacitor is substantially the same as a predetermined driving voltage, that is, the voltage that realizes appropriate ink ejection, even when, for example, a printing condition is employed in which solid printing is performed on the whole area of a recording paper, that is, the driver IC 52 has the maximum load for driving the actuator unit 21. In this case, even when the driver IC 52 has the maximum load, the operation of the capacitor 60 having an appropriate capacitance can keep the voltage to be applied between individual electrodes 35 and the common electrode 34, at a driving voltage necessary for realizing appropriate ink ejection. Thus, ink is surely ejected out of each nozzle 8.

In driving the actuator unit 21, however, in some cases, a large ripple current is instantaneously required that exceeds the capability of the head driving power source 92. In such a case, the ripple current flows through the capacitor 60 that supplementarily serves for power supply. Heats generated due to the ripple current increases the internal temperature of the capacitor 60. When the internal temperature exceeds the rated temperature of the capacitor 60, this shortens the life of the capacitor 60. Actually, therefore, the increase in the internal temperature must be also taken into consideration to determine the capacitance of the capacitor 60.

Because the loss generated in the capacitor 60 due to the DC component is vanishingly small, the loss in the capacitor 60 is the product of the square of the ripple current as the AC component and the equivalent series resistance in the capacitor 60. The almost whole of the loss results in heat generation. When the capacitor 60 is put in the thermal equilibrium state, the increase in the temperature of the capacitor 60 is proportional to the heat generation quantity. That is, the increase in the temperature of the capacitor 60 is proportional to the equivalent series resistance in the capacitor 60 and the square of the ripple current. Therefore, to suppress the increase in the temperature of the capacitor 60, the equivalent series resistance is preferably as low as possible.

In general, however, the higher the capacitance of the capacitor 60, the lower the equivalent series resistance is. Therefore, when the increase in the internal temperature due to the ripple current is intended to be suppressed, a capacitor of a high capacitance is required. In particular, in the case of an inkjet head in which many PZT capacitors are driven at once and a large ripple current is frequently generated in the capacitor 60, generally, in many cases, the increase in the temperature due to the ripple current is considered as a constrained condition for determining the capacitance of the capacitor 60, more than the above-described voltage drop suppression condition.

The above will be described in more detail by using a concrete example. In a simplified manner, the ripple current can be calculated as follows. When V represents the driving voltage to be applied between each individual electrode 35 and the common electrode 34; F represents the driving frequency; C represents the capacitance of one PZT capacitor of the actuator unit 21; n represents the number of PZT capacitors to be charged at once, that is, the number of individual electrodes 35 to which the driving voltage V is applied at the same time; and Ip represents the charging peak current of the driver IC 52, the equivalent driving time t is t=V×C/Ip and thus the ripple current Ir is given by the following Expression 2.
Ir=n·Ip·\sqrt{t·F}=n·√\sqrt{Ip·F·C·V} [Expression 2]

For example, when the capacitance C of one PZT capacitor corresponding to one nozzle is 220 pF; the driving voltage V of the driver IC 52 is 20 V; the driving current Ip of the driver IC 52 is 5 mA; the driving frequency F is 100 kHz; and ink is ejected from 2656 nozzles at the same time, that is, n=2656, the ripple current Ir is 3.94 Arms from the Expression 2. That is, the ripple current is estimated at about 4 A.

On the other hand, when the capacitance C of the capacitor 60 necessary for putting the driving voltage drop within 1% under the same conditions is calculated by using the above-described Expression 1, C=57.8 microfarad. That is, from the viewpoint of suppressing the voltage drop, it is only necessary to adopt a capacitor 60 of 35 V/68 microfarad. In general, however, any capacitor of 35 V/68 microfarad can not accept such a large ripple current as 4 A. The general rated value of the ripple current of the capacitor of this kind is about 0.2 to 0.4 Arms.

Therefore, due to the ripple current constraint, a number of capacitors each having a higher capacitance must be provided in parallel. However, such a capacitor 60 is larger in size than other electronic parts. In particular, the tendency becomes remarkable as the capacitance increases. This hinders reduction of the size of the inkjet head 2. In addition, the higher the capacitance is, the more the capacitor 60 is expensive. Further, provision of a number of capacitors 60 brings about an increase in cost of the apparatus.

For the above reason, in each inkjet head 2 of this embodiment, a capacitance 60 having a relatively low capacitance, capable of sufficiently suppressing the voltage drop, is adopted. In addition, the head controller 83 monitors the internal temperature of the capacitor 60. Further, the driver IC 52 is controlled so as to prevent the internal temperature of the capacitor 60 from excessively increasing.

For monitoring the internal temperature of the capacitor 60 by the head controller 83, the temperature of the capacitor 60 must be detected by some means. However, provision of a purpose-built temperature detector, for example, a thermocouple, for the capacitor 60, is undesirable because it brings about an increase in cost.

In this embodiment, as described above, the driver IC 52 originally has therein the driver temperature detector 86 for monitoring the operation temperature. Further, the environmental temperature detector 87 for detecting the environmental temperature is provided on the head substrate 54 of the inkjet head 2. The operation temperature of the driver IC 52 and the environmental temperature and the internal temperature of the capacitor 60 have the following relation.

When the driver IC 52 drives the actuator unit 21, that is, charges or discharges PZT capacitors, loss arises. When F represents the driving frequency; V represents the driving voltage; and C represents the total of the capacitances of PZT capacitors of the actuator unit 21 to be driven, that is, charged or discharged, at once, the loss Pd is equal to FCV². Further, on the assumption that the whole loss Pd is converted into heats, when R represents the thermal resistance determined by a radiator plate and radiating conditions; and delta T represents an increase in the temperature of the driver IC relative to the environmental temperature, delta T is equal to Pd×R. It is assumed that R contains the thermal resistance of the driver IC 52 itself and the thermal resistance on the surface in contact with the radiator plate.

On the other hand, the current I for driving the actuator 21 is equal to FCV because Q=CV. Thus, when the driving voltage V is constant, the current I is proportional to the loss Pd in the driver IC 52. That is, the temperature increase delta T of the driver IC 52 is proportional to the current I for driving the actuator 21. Therefore, it is understood that the ripple current and the quantity of generated heats in the driver IC 52 are also in proportional relation. In addition, as described above, the quantity of generated heats in the capacitor 60, that is, loss in the capacitor 60, is proportional to the square of the ripple current. From those relations, it is understood that the operation temperature of the driver IC 52 and the environmental temperature are in a predetermined relation to the internal temperature of the capacitor 60. Thus, the internal temperature of the capacitor 60 can be estimated on the basis of the operation temperature of the driver IC 52 and the environmental temperature.

Therefore, as shown in FIG. 7, the head controller 83 includes therein a temperature estimating unit 84 that estimates the internal temperature of the capacitor 60 on the basis of the operation temperature of the driver IC 52 detected by the driver temperature detector 86 and the environmental temperature detected by the environmental temperature detector 87. The temperature estimating unit 84 has therein the following Table 1 that relates the operation temperature of the driver IC 52 and the environmental temperature to the internal temperature of the capacitor 60.

TABLE 1

| | t = 0 s | | t = 5 s | | t = 10 s | | t = 15 s | | t = 20 s | | t = 25 s | | t = 30 s | |
|---|---|---|---|---|---|---|---|---|---|---|---|---|---|---|
| Ta | ΔTd | ΔTc | ΔTd | ΔTc | ΔTd | ΔTc | ΔTd | ΔTc | ΔTd | ΔTc | ΔTd | ΔTc | ΔTd | ΔTc |
| −10 | 0.0 | 0.0 | 13.6 | 10.4 | 27.2 | 20.8 | 40.9 | 31.2 | 54.5 | 41.6 | 68.1 | 52.0 | 81.7 | 62.4 |
| 0 | 0.0 | 0.0 | 12.4 | 9.9 | 24.7 | 19.8 | 37.1 | 29.7 | 49.5 | 39.7 | 61.8 | 49.6 | 74.2 | 59.5 |
| 10 | 0.0 | 0.0 | 11.2 | 9.4 | 22.3 | 18.8 | 33.5 | 28.3 | 44.7 | 37.7 | 55.8 | 47.1 | 67.0 | 56.5 |
| 20 | 0.0 | 0.0 | 10.0 | 8.9 | 20.1 | 17.9 | 30.1 | 26.8 | 40.1 | 35.7 | 50.1 | 44.6 | 60.2 | 53.6 |
| 30 | 0.0 | 0.0 | 9.0 | 8.4 | 17.9 | 16.9 | 26.9 | 25.3 | 35.8 | 33.7 | 44.8 | 42.2 | 53.7 | 50.6 |
| 40 | 0.0 | 0.0 | 7.9 | 7.9 | 15.9 | 15.9 | 23.8 | 23.8 | 31.8 | 31.8 | 39.7 | 39.7 | 47.6 | 47.7 |
| 50 | 0.0 | 0.0 | 7.0 | 7.5 | 14.0 | 14.9 | 21.0 | 22.4 | 27.9 | 29.8 | 34.9 | 37.3 | 41.9 | 44.7 |
| 60 | 0.0 | 0.0 | 6.1 | 7.0 | 12.2 | 13.9 | 18.3 | 20.9 | 24.4 | 27.8 | 30.5 | 34.8 | 36.5 | 41.8 |

(Unit: ° C.)

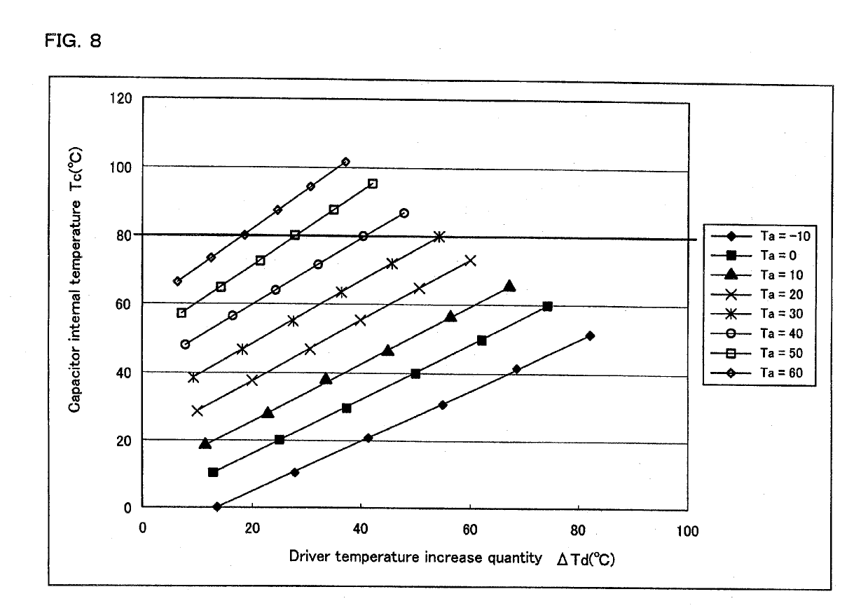

In the table 1, t represents the successive driving time of the actuator unit 21, that is, the successive recording operation time of the printer 1. The values of t are given from zero seconds to thirty seconds at intervals of five seconds. In the Table 1, Ta represents the environmental temperature in a unit of degree C.; and delta Td and delta Tc represent the respective temperature increase quantities, in a unit of degree C., of the driver IC 52 and the capacitor 60 relative to the environmental temperature Ta. FIG. 8 is a graph corresponding to the Table 1. In FIG. 8, the axis of abscissas represents delta T and the axis of ordinate represents the capacitor internal temperature Tc, which is equal to delta Tc+Ta, for each value of the environmental temperature Ta. By referring to the Table 1, corresponding to FIG. 8, the temperature estimating unit 84 estimates the internal temperature Tc of the capacitor 60 on the basis of the operation temperature Td and environmental temperature Ta of the driver IC 52. Thus, the internal temperature Tc can easily be estimated.

Table 1 may be obtained by calculation based on a theoretical relation of the operation temperature of the driver IC 52 and the environmental temperature to the internal temperature of the capacitor 60. In this embodiment, however, in order to cope with a change in the viscosity of ink in accordance with the environmental temperature, the head controller 83 changes the driving voltage to be applied from the driver IC 52 between each individual electrode 35 and the common electrode 34, in accordance with the environmental temperature. Due to such a change in the driving voltage or other conditions, in many cases, the actual relation of the operation temperature of the driver IC 52 and the environmental temperature to the internal temperature of the capacitor 60 differs from the above-described relation derived theoretically. For this reason, Table 1 that relates the operation temperature of the driver IC 52 and the environmental temperature to the internal temperature of the capacitor 60, is preferably obtained by actual measurement. Even when Table 1 is theoretically derived, it is preferably corrected by actual measurement.

When the internal temperature Tc of the capacitor 60 estimated by the temperature estimating unit 84 as described above exceeds a predetermined permissible temperature T0, for example, 80 degrees C., lower than the rated temperature of the capacitor 60, the driver controller 85 makes the driver IC 52 stop applying the driving voltage between individual electrodes 35 and the common electrode 34, and inhibits the driver IC 52 from driving the actuator unit 21 till the internal temperature Tc decreases to the permissible temperature T0 or less. Thereby, because no ripple current flows in the capacitor 60, the internal temperature of the capacitor 60 increases no more. Thus, an excessive increase in the temperature is prevented.

At the same time, information that the internal temperature Tc of the capacitor 60 has exceeded the permissible temperature T0 is sent from the head controller 83 to the printer controller 80. The printer controller 80 then stops the paper feed motor 81 for the paper feeder 114 and the conveyance motor 82 for the conveyance unit 120 so as to stop feeding recording papers P to the inkjet heads 2. Thus, the recording operation of the printer 1 onto the recording papers P is inhibited till the internal temperature Tc of the capacitor 60 decreases to the permissible temperature T0 or less.

When the environmental temperature Ta is low, there is low probability that the internal temperature Tc of the capacitor 60 exceeds the permissible temperature T0. There are few cases wherein an increase in the internal temperature of the capacitor 60 becomes problems. As shown in FIG. 8, when the environmental temperature Ta is low, for example, Ta=−10 degrees C., the operation temperature of the driver IC 52 exceeds the operation upper limit temperature, for example, 100 degrees C., before the internal temperature Tc of the capacitor 60 exceeds the permissible temperature, for example, 80 degrees C. In this case, on the basis of the operation temperature Td of the driver IC 52, the driver controller 85 inhibits the driver IC 52 from driving the actuator unit 21, irrespective of the internal temperature Tc of the capacitor 60. Therefore, the temperature estimating unit 84 may be constructed so that it does not refer to Table 1, corresponding to FIG. 8, and does not estimate the internal temperature Tc of the capacitor 60 when the environmental temperature Ta is low.

For example, in this embodiment, as shown in Table 1, the quantities of increases in the temperatures of the driver IC 52 and the capacitor 60 to the successive driving time of the actuator unit 21 are substantially equal to each other when the environmental temperature Ta is 40 degrees C. When the environmental temperature Ta is not more than 40 degrees C., the driver IC 52 is directly driven on the basis of the detection result of the driver temperature detector 86 without estimating the internal temperature of the capacitor 60. That is, the head controller 83 operates in two modes of a mode in which the driver IC 52 as an element driver is driven by estimating the internal temperature of the capacitor 60 and a mode in which the driver IC 52 is driven without estimating the internal temperature of the capacitor 60. These modes are switched over at the environmental temperature Ta=40 degrees C.

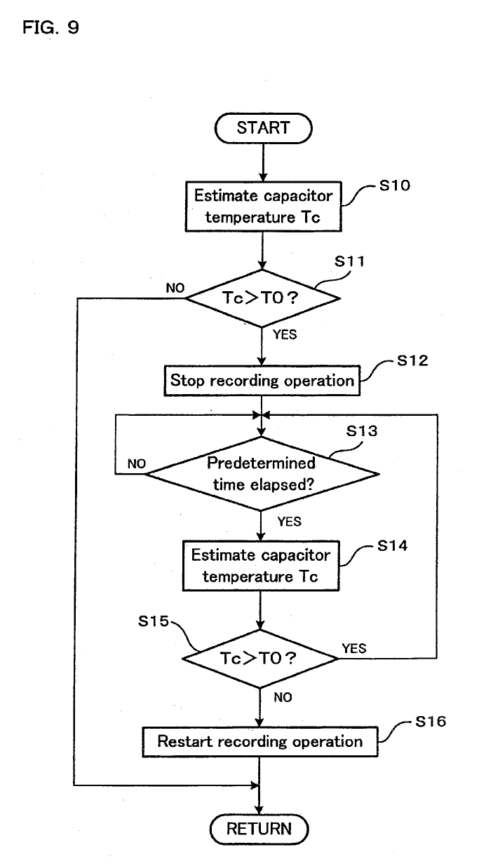

Next, a series of controls by the head controller 83 and the printer controller 80, including estimation of the internal temperature of the capacitor 60 and stopping the recording operation of the printer 1 on the basis of the estimation, will be described with reference to the block diagram of FIG. 7 and the flowchart of FIG. 9. In FIG. 9, Si (i=10, 11, 12, . . . ) represents each step.

First, in Step S10, on the basis of Table 1, corresponding to FIG. 8, the temperature estimating unit 84 of the head controller 83 estimates the internal temperature Tc of the capacitor 60 from the operation temperature Td of the driver IC 52 detected by the driver temperature detector 86 and the environmental temperature Ta detected by the environmental temperature detector 87. Although the temperature estimation may be performed at any timing, it is performed at every timing when recording on one recording paper P is completed, in the below description.

When the estimated internal temperature Tc is not more than the permissible temperature T0, that is, No in Step S11, the recording operation is judged to be able to be further continued and the flow returns without any processing. On the other hand, when the estimated internal temperature Tc is more than the permissible temperature T0, that is, Yes in Step S11, the flow advances to Step S12, in which the recording operation of the printer 1 onto the recording paper P is stopped. That is, the printer controller 80 stops the paper feed motor 81 and the conveyance motor 82 and thereby stops the feed of recording papers P to the inkjet heads 2 by the paper feeder 114 and the conveyance unit 120. Further, the driver controller 85 of the head controller 83 controls the driver IC 52 to stop driving the actuator unit 21.

When a predetermined time has elapsed after the precedent temperature estimation, that is, Yes in Step S13, the flow advances to Step S14, in which the temperature estimating unit 84 again estimates the internal temperature Tc of the capacitor 60 on the basis of the operation temperature Td of the driver IC 52 and the environmental temperature Ta. While the estimated internal temperature Tc is more than the permissible temperature T0, a series of Steps S13, S14, and S15 are repeated. When the internal temperature Tc decreases to the permissible temperature T0 or less, that is, No in Step S15, the flow advances to Step S16, in which the recording operation is restarted. That is, the printer controller 80 allows the paper feeder 114 and the conveyance unit 120 to restart the feed of recording papers P to the inkjet heads 2. Further, the driver controller 85 of the head controller 83 controls the driver IC 52 to restart driving the actuator unit 21.

According to the above-described printer 1, the following advantages are obtained. The internal temperature of the capacitor 60 is estimated from the operation temperature of the driver IC 52 detected by the driver temperature detector 86 and the environmental temperature detected by the environmental temperature detector 87. Further, when the estimated temperature of the capacitor 60 exceeds the permissible temperature, the driver IC 52 is inhibited from driving the actuator unit 21. Thus, even when an inexpensive capacitor 60 having a low capacitance is adopted in order to realize reductions in cost and size of the printer 1, it can surely be prevented that the internal temperature of the capacitor 60 excessively increases and thereby the life of the capacitor 60 is shortened. In addition, there is no need of provision of any purpose-built temperature sensor or the like only for monitoring the internal temperature. This further suppresses the cost. Further, because the internal temperature of the capacitor 60 is estimated on the basis of both of the operation temperature of the driver IC 52 and the environmental temperature, this increases the accuracy of the temperature estimation.

Next, modifications in which the above embodiment is variously modified will be described. In the modifications, components having the same constructions as those of the embodiment are denoted by the same reference numerals as in the embodiment, respectively, and the description thereof may be arbitrarily omitted.

(1) In the printer 1 of the embodiment, when the internal temperature of the capacitor 60 estimated by the temperature estimating unit 84 exceeds a predetermined permissible temperature, the driver controller 85 inhibits the driver IC 52 from driving the actuator unit 21, to suspend the recording operation of the printer 1. In a modification, however, the driver controller 85 may temporarily extend the driving interval of the driver IC 52 for the actuator unit 21. Such extension of the driving interval for the actuator unit 21 decreases the quantity of heats generated in the capacitor 60 per unit of time. Therefore, like the embodiment, even when an inexpensive capacitor 60 having a low capacitance is adopted, the internal temperature of the capacitor 60 is prevented from excessively increasing. When the driving interval for the actuator unit 21 is extended, the printer controller 80 reduces the revolutions of the paper feed motor 81 and the conveyance motor 82 simultaneously with the extension of the driving interval, to reduce the conveyance speed of each recoding paper P. That is, the recoding rate of the printer 1 onto the recording paper P is temporarily lowered.

(2) Although the inkjet heads of the embodiment are line type inkjet heads, the present invention can be applied also to a printer having therein a so-called serial type inkjet head 2 carried on a carriage that reciprocates laterally of a recording paper P. In this modification, the temperature estimating unit 84 estimates the internal temperature of the capacitor 60 after one scanning operation of the carriage. When the estimated internal temperature exceeds a predetermined permissible temperature, the next scanning operation of the carriage is inhibited and the driver IC 52 is inhibited from driving the actuator unit 21.

(3) The temperature estimating unit 84 may be constructed so as to estimate a hypothetical internal temperature of the capacitor 60 on the assumption that the actuator unit 21 was driven next time. In this modification, when the estimated hypothetical internal temperature exceeds a predetermined permissible temperature, the driver controller 85 inhibits the driver IC 52 from driving the actuator unit 21, or extends the driving interval.

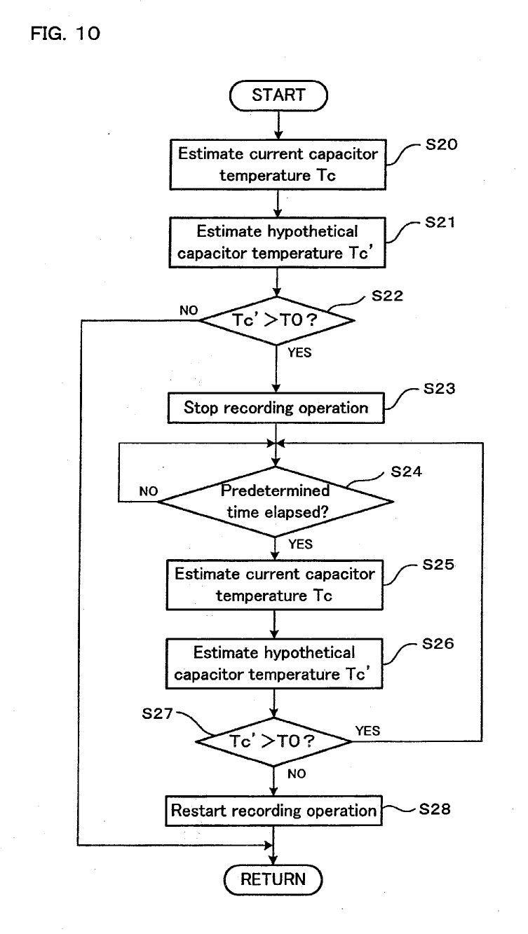

A series of controls by the head controller 83 and the printer controller 80 according to this modification will be described in detail with reference to the flowchart of FIG. 10. First, in Step S20, by referring to the above-described Table 1, the temperature estimating unit 84 of the head controller 83 estimates the current internal temperature Tc of the capacitor 60 from the operation temperature Td of the driver IC 52 detected by the driver temperature detector 86 and the environmental temperature Ta detected by the environmental temperature detector 87.

In Step S21, the temperature estimating unit 84 estimates the temperature increase quantity delta Tc′ on the assumption that the next recording operation, that is, the next driving operation for the actuator unit 21, was performed. From the current internal temperature Tc of the capacitor 60 and the temperature increase quantity delta Tc′, the temperature estimating unit 84 then calculates a hypothetical internal temperature Tc′ of the capacitor 60 on the assumption that the recording operation was performed.

The hypothetical temperature increase quantity delta Tc′ can be obtained as follows. To obtain it in the simplest manner, the temperature increase quantity delta Tc′ of the capacitor 60 per one recording operation is considered to be always constant irrespective of an image or the like to be recorded, and it is set to a value given by actual measurement.

In another manner, from input data of an image or the like to be recorded, it is possible to calculate the total number of PZT capacitors to be driven, that is, the total number of nozzles that eject ink, in one recording operation of an inkjet head 2, for example, recording of one page in the case of a line type head or one scanning operation of the carriage in the case of a serial type head. Therefore, the head controller 83 has therein a table that relates the total number of PZT capacitors to be driven in one recording operation, to the temperature increase quantity of the capacitor 60, and the temperature estimating unit 84 estimates a hypothetical temperature increase quantity delta Tc′ of the capacitor 60 on the basis of the table.

In still another manner, the power consumption per unit of time is calculated from the total number of PZT capacitors to be driven in one recording operation. The temperature estimating unit 84 estimates a temperature increase quantity delta Tc′ of the capacitor 60 by calculation on the basis of the power consumption.

When the hypothetical internal temperature Tc′ thus estimated is more than a predetermined permissible temperature T0, that is, Yes in Step S22, the flow advances to Step S23, in which the recording operation of the printer 1 is inhibited. Further, in Steps S24, S25, and S26, when a predetermined time has elapsed after the precedent temperature estimation, the temperature estimating unit 84 again estimates a hypothetical internal temperature Tc′ of the capacitor 60. When the estimated internal temperature Tc′ is not more than the permissible temperature T0, that is, No in Step S27, the flow advances to Step S28, in which the recording operation is restarted.

According to this modification, when it is predicted that the internal temperature Tc of the capacitor 60 exceeds the permissible temperature T0, the driver IC 52 is inhibited from driving the actuator unit 21. This prevents the internal temperature of the capacitor 60 from exceeding the permissible temperature. Thus, an excessive increase in the temperature of the capacitor 60 is prevented more surely.

(4) In the embodiment, the temperature estimating unit 84 estimates the internal temperature of the capacitor 60 on the basis of both of the operation temperature of the driver IC 52 and the environmental temperature. However, when variation of the environmental temperature around the capacitor 60 is little, for example, about plus or minus 5 degrees C., and the variation hardly influences the estimation of the temperature of the capacitor 60 by the temperature estimating unit 60, because, for example, as shown in FIG. 2, the actuator unit 21, the FPC 50, and the head substrate 54 are covered with the cover unit 58 so that the environmental temperature is stable, the environmental temperature can be considered to be constant. In this case, the temperature estimating unit 84 can estimate the internal temperature of the capacitor 60 on the basis of only the operation temperature of the driver IC 52.

(5) It is not always necessary that the driver controller 85 automatically changes the operation state of the driver IC 52, for example, inhibits the driver IC 52 from driving the actuator unit 21 or extends the driving interval, on the basis of the internal temperature of the capacitor 60 estimated by the temperature estimating unit 84. For example, when the estimated internal temperature of the capacitor 60 exceeds the permissible temperature, a message may be displayed or a warning lamp may be lit so as to invite the user's attention.

(6) Each recording element of the present invention is not limited to that using a piezoelectric actuator as in the embodiment. The present invention can be applied also to a recording apparatus including therein any other known recording element, for example, in which heat is given to ink in a passage to form a bubble and thereby ink is ejected through a nozzle, or heat is given to an ink ribbon to transfer ink onto a recording paper.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A recording apparatus comprising:
an element driver that drives a recording element;
a driver controller that controls the element driver;
a capacitor electrically connected to the element driver;
a first temperature detector that detects an operation temperature of the element driver; and
a temperature estimating unit that estimates an internal temperature of the capacitor on the basis of the operation temperature of the element driver detected by the first temperature detector.

2. The apparatus according to claim 1, wherein the apparatus further comprises a second temperature detector that detects a surrounding environmental temperature, and
the temperature estimating unit estimates the internal temperature of the capacitor on the basis of the operation temperature of the element driver detected by the first temperature detector and the environmental temperature detected by the second temperature detector.

3. The apparatus according to claim 2, wherein the temperature estimating unit has a table that relates the operation temperature of the element driver and the environmental temperature to the internal temperature of the capacitor.

4. The apparatus according to claim 1, wherein, when the internal temperature of the capacitor estimated by the temperature estimating unit exceeds a predetermined temperature, the driver controller inhibits the element driver from driving the recording element till the internal temperature of the capacitor decreases to not more than the predetermined temperature.

5. The apparatus according to claim 1, wherein the driver controller extends an interval of driving the recording element by the element driver when the internal temperature of the capacitor estimated by the temperature estimating unit exceeds a predetermined temperature.

6. The apparatus according to claim 1, wherein the temperature estimating unit estimates a hypothetical internal temperature of the capacitor on the assumption that the element driver drove the recording element, and
when the hypothetical internal temperature of the capacitor estimated by the temperature estimating unit exceeds a predetermined temperature, the driver controller inhibits the element driver from driving the recording element till the hypothetical internal temperature decreases to not more than the predetermined temperature.

7. The apparatus according to claim 1, wherein the recording element is bonded to a passage unit in which a nozzle that ejects ink and an ink passage connected with the nozzle, are formed, so that the recording element makes ink be ejected from the nozzle when the element driver applies a driving voltage to the recording element, and
the capacitor is connected in parallel with the element driver, and has a capacitance such that at least a voltage to be applied to the recording element is kept at the driving voltage when the element driver has the maximum load for driving the recording element.
